(19) United States
(12) Patent Application Publication
(10) Pub. No.: US 2013/0002565 A1
(43) Pub. Date: Jan. 3, 2013

(54) DETECTING PORTABLE DEVICE ORIENTATION AND USER POSTURE VIA TOUCH SENSORS

(75) Inventors: Ilya Tumanov, Redmond, WA (US); David Benjamin Lee, Sammamish, WA (US)

(73) Assignee: Microsoft Corporation, Redmond, WA (US)

(21) Appl. No.: 13/171,417

(22) Filed: Jun. 28, 2011

(51) Int. Cl. G06F 3/041

(52) U.S. Cl. 345/173

(57) ABSTRACT

Concepts and technologies are described herein for processing touch sensor signals from sensors located on a portable touch screen device along with accelerometer data, to determine if, and how, the device is currently being used. Data from touch sensors along with accelerometer data are analyzed to identify a manner in which the device is being held, including how the user is holding the device. The touch sensor signals can be used to better control the device, including placing the device into a sleep state, and waking up the device. The touch sensor signals can also be used to configure the display contents, including where to locate various virtual keys or function keys on the screen or how to present a virtual keyboard based on how the user is holding and using the device.

### BACKGROUND

Portable devices frequently incorporate touch sensors on the display (“touch screen”) to facilitate user input to an application or controlling the device. Using a touch screen, users are directed to touch an area on the display screen to provide input indicating data or selecting a control function to be performed. Typically, an icon is presented on the display screen to the user, and the icon is generated by the device's operating system or an application program. In one instance, the icons can represent keys of a keyboard, and thus a virtual keyboard or function keys can be presented as needed to the user.

Portable devices also frequently incorporate accelerometers which can detect position or movement of the device itself. These devices can measure static acceleration due to gravity, and/or can be used to measure tilt, orientation or the angle of the device. In addition, accelerometers can also measure motion or movement of the device. Accelerometers can be used to measure an orientation of the portable device with respect to the ground. Thus, accelerometers can be used when reorienting the display content on a portable device from a landscape mode to a portrait mode, or vice versa.

Using just an accelerometer to determine how to reorient the screen display content is not always reflective of how the user is using the device, however. The accelerometer may detect a change in position that triggers reconfiguration of the screen display contents, but such reconfiguration may be undesirable from the user's view. Thus, more accurate methods are required for controlling the reconfiguration of a portable device's display contents in light of how the user is using the device.

It is with respect to these and other considerations that the disclosure made herein is presented.

### SUMMARY

Concepts and technologies are described herein for receiving touch sensor data from a plurality of sensors located on a portable touch screen device and using the touch sensor signals to control operation of the portable touch screen device. In one embodiment, the touch sensors are positioned on the back side of the portable device, which is the side opposite of the display side. The touch sensors generate signals when touched by the user. The placement of the touch sensors allows the device to determine a usage position of the device reflecting how the user is holding the device, such as whether the user is holding the device with one hand or two hands.

A processor may compare the touch sensor data from the touch sensors with previously stored touch sensor data in a memory to aid in determining the usage position. The processor may also receive signals from an accelerometer and use the accelerometer signals in conjunction with the touch sensor signals to determine the usage position. Once the usage position has been determined, the processor may then reconfigure the screen display content in response.

According to one aspect, the processor may reconfigure the screen display content by displaying certain icons on the screen in response to the determined usage position. The displayed icons may include virtual keys of a keypad or function keys. The location of the virtual keys may be positioned differently for different usage positions. According to another aspect, the processor may reconfigure the screen display content by reorienting the display content in response to the usage position of the device.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an exemplary embodiment of touch sensors on a portable touch screen device according to the various embodiments disclosed herein.

FIGS. 2A-2C illustrate various exemplary user handhold positions of a portable touch screen device having touch sensors according to various embodiments disclosed herein.

FIGS. 3A-3C illustrate various aspects of configuring the display screen content according to various embodiments disclosed herein.

FIG. 4 is a flow diagram showing aspects of a method for modifying operation of a portable touch screen device, according to the exemplary embodiments disclosed herein.

FIG. 5 is a flow diagram showing aspects of a method for displaying a virtual keyboard, according to an exemplary embodiment disclosed herein.

FIG. 6 illustrates one display format for displaying and orienting a virtual keyboard, according to an exemplary embodiment disclosed herein.

FIG. 7 is a computer architecture diagram illustrating an exemplary computer hardware and software architecture for a portable touch screen device capable of implementing aspects of the embodiments presented herein.

### DETAILED DESCRIPTION

The following detailed description is directed to technologies for analyzing sensor related data from a portable device, and for controlling operation of the portable device in response thereto. According to various concepts and technologies disclosed herein, the portable device incorporates touch sensors, and receives touch signals when touched by a user. The touch signals can be processed along with accelerometer signals to determine a usage position of the device. The operation of the portable device can be controlled in accordance with the usage position of the device.

While the subject matter described herein is presented in the general context of program modules that execute in conjunction with the execution of an operating system and application programs on a portable computer system, those skilled in the art will recognize that other implementations employing the principles of the present invention may be performed in combination with other types of program modules. Generally, program modules include routines, programs, components, data structures, and other types of structures that perform particular tasks or implement particular data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for gathering sensor data and controlling operation of the portable device is presented.

Portable computing devices are prevalent today, and comprise various brands and types of smart phones, personal digital assistants, netbooks, computer notebooks, e-readers, and tablets. Some of these devices, such as notebooks or netbooks incorporate a physical keyboard. Though these are portable, they are typically designed for data entry by positioning the device on a relatively flat and stable surface and typing on the keyboard in a conventional manner. Other devices, such as smart phones, tablets, and even some cameras, may incorporate touch screens and do not have a conventional keyboard with discrete physical keys. Rather, these devices have a “virtual keyboard” that is represented as icons on the touch screen, where the icons represent a virtual key on the keypad. An indicia is typically represented with the virtual key on the display screen to indicate its corresponding function. The touch screens on these portable devices are able to detect a user touching a particular portion of the screen, and touching a particular location of the screen invokes the corresponding function or provides the corresponding data associated with the virtual key.

One such common touch screen device is a tablet computer (or simply “tablet”). Tablet computers are characterized by a relatively large touch screen compared to the silhouette profile of the device. For reference purposes, the touch screen side is referred as being on the “front” or “top” of the device, and the other side is the “back.” Use of this terminology does not imply a certain position of the device. Specifically, referring to the display side as the “top” does not necessarily means that the tablet is laying on a flat surface. Because the touch screen on a tablet comprises the majority of the top surface of the device, tablets do not have a physical keyboard as found in notebook or netbook computers. Rather, tablets rely on a software defined virtual keyboard that can be displayed when necessary to the user.

Tablet computers are larger than many smartphones, and typically do not fit in a pocket, which most cellphones readily do. The screen of the tablet computer is larger compared to a smart phone, and consequently, the virtual keyboard is usually larger than what can be displayed on a smart phone. Many smart phones also have physical numerical or alphanumeric keys. Because of the larger size of the tablet, there are subtle differences in how the tablet computer is held and used relative to a smartphone. A smartphone can usually be readily held in one hand by grasping the side edges in one hand. Dialing or typing is usually accomplished by using a single finger (sometime referred to as the “hunt-and-peck” method of typing). The small layout of the smartphone may make it difficult to use two hands positioned over the virtual keypad to type in a conventional manner, whereas a conventional typing posture can be used with a tablet device.

When a tablet computer is used by typing in a conventional typing manner (e.g., using fingers and thumbs of both hands for selecting keys), the tablet computer cannot be held by the user's hands. The tablet computer must be positioned on a surface, table, the user's leg (when the user is sitting), or the users' lap. In contrast, a smart phone is typically not used by placing it in the user's lap—its small size can make this impractical. While a smart phone can be placed on a table or other flat surface during use, typically the small size of the screen can be easier seen by holding the smart phone in one hand in front of the user's face. It can be difficult for a user to type in a conventional manner on a smart phone, given the small size of the virtual keys.

A tablet may also be held differently than a smart phone. A smart phone can be readily grasped at the sides of the device between the finger(s) and thumb. Many smart phones have a rectangular shape, so that the device can be grasped at the side edges when vertically oriented, or grasped from the top-to-bottom edges when the smart phone is in the horizontal position. Most tablets also have a rectangular shape, but these are typically too wide for the typically human hand to comfortably grasp side-to-side (regardless of whether this is the shorter or longer side of the tablet). The tablet can be held by pinching the device using one hand (e.g., thumb and the finger(s)), or using two hands to hold the side edges with the fingers behind the device. Thus, there can be distinctions between how a tablet device is held as compared to how a smartphone device is held.

Further, how a tablet device is used can be different than a smart phone. While both tablets and smart phones can be used to compose and read email, reading a section of a book or manual using a smart phone would be more difficult than using a tablet. Tablet computers also have certain advantages when used to share viewing of documents, graphs, view video, etc. Thus, the use of tablets can differ from using a smart phone. For example, a tablet device can be used by a salesperson to provide graphical product images to a customer. The salesperson may access images, and present them to the customer. Typically, the tablet is positioned so that both parties can see the image. Doing so with is less likely to occur using a smart phone, due to its small screen image simultaneously. Thus, a tablet may be frequently used for shared viewing of the display. Thus, what a tablet is used for, in addition to how the tablet is held, may be distinguished from a smart phone.

In some instances, the use of the tablet may be similar to a smartphone. Some tablets have voice communications capability, although it is typically not common to hold a tablet device up to the side of the head as is often done with a smart phone. However, certain tablets can be used in a speakerphone mode of operation.

As used herein, the scope of the term “portable touch screen device” (“PTS”) device refers to a portable touch screen computing device that lacks a conventional, built-in dedicated physical keyboard. However, PTS devices may encompass devices that have various physical controls on the device, in addition to the touch screen. For example, a PTS device may have a physical on/off switch, volume control, reset button, volume or ringer control, etc. The presence of these physical controls does not necessarily exclude the device from being a PTS device.

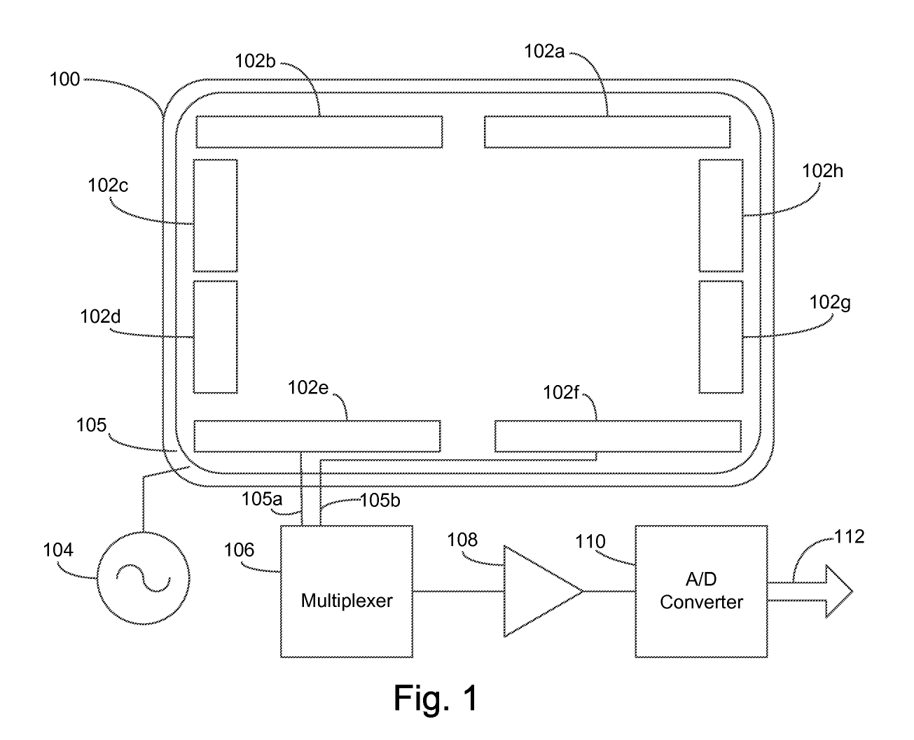

As discussed above, PTS devices of a certain size, such as a tablet, are used and handled differently than PTS devices having a smaller size, e.g., smart phones. PTS devices, including both tablets and smart phones, can benefit from incorporating touch sensors on the back side of the device used by the device's processor to control operation of the device. One embodiment of the touch sensor layout is shown in FIG. 1. FIG. 1 illustrates various touch sensors 102a-102h (collectively referred to as 102) positioned around the back of the PTS device 100. FIG. 1 illustrates a plane view of the back side of the device, so that the display surface is on the other side. The touch sensors may not be readily visible, and their presence may not be readily detected by the user.

Several touch sensors 102a, 102b are located horizontally (when the PTS device is in the position shown in FIG. 1) and can extend across the top back of the device. Corresponding horizontal touch sensors 102f, 102e are located on the bottom. Similarly, touch sensors 102h, 102g, 102c, 102d are located on the sides. Of course, when the PTS device is rotated 90 degrees, the touch sensors 102a, 102b, 102e, 102f are then located on the sides of the device, and the touch sensors 102g, 102h, 102c, 102d are then positioned on the top and bottom. Other configurations and numbers of the touch sensors are possible, and FIG. 1 illustrates only one embodiment. For purposes herein, it is assumed the device is rectangular in shape, and that when the longer sides are horizontal relative to the user viewing the device, the device is said to be positioned horizontally. This does not imply that the back surface is necessarily flat or tilted. Later on, as it will be seen, the characterization of whether the device is horizontal relative to the user can be different than whether the device is horizontal relative to gravity.

The circuitry for detecting touch can be based on a variety of technologies. In FIG. 1, a capacitive touch switch arrangement is illustrated, which comprises an oscillator 104 providing a reference signal to contact 105 that borders the perimeter of the device 100. When the user touches a touch sensor, a modified oscillating wave signal is then provided, and the resulting signal is conveyed by a lead to a multiplexer 106. For example, touch sensor 102f is shown connected via a lead 105a to the multiplexer 106. Similarly, touch sensor 102e is connected via a lead 105b, and so forth. Other leads for other touch sensors are not shown for simplicity. The multiplexer allows signals from each of the touch sensors to be provided to an amplifier 108, which then provides the amplified oscillating signal to an analog-to-digital converter 110, which in turn provides a quantified data result 112 to a processor (not shown in FIG. 1). The capacitance from the user's body impacts the frequency and/or amplitude of oscillation and this variation is detected. In some embodiments, the amount of pressure provided can also be detected as well, since it impacts the amount of area contacted.

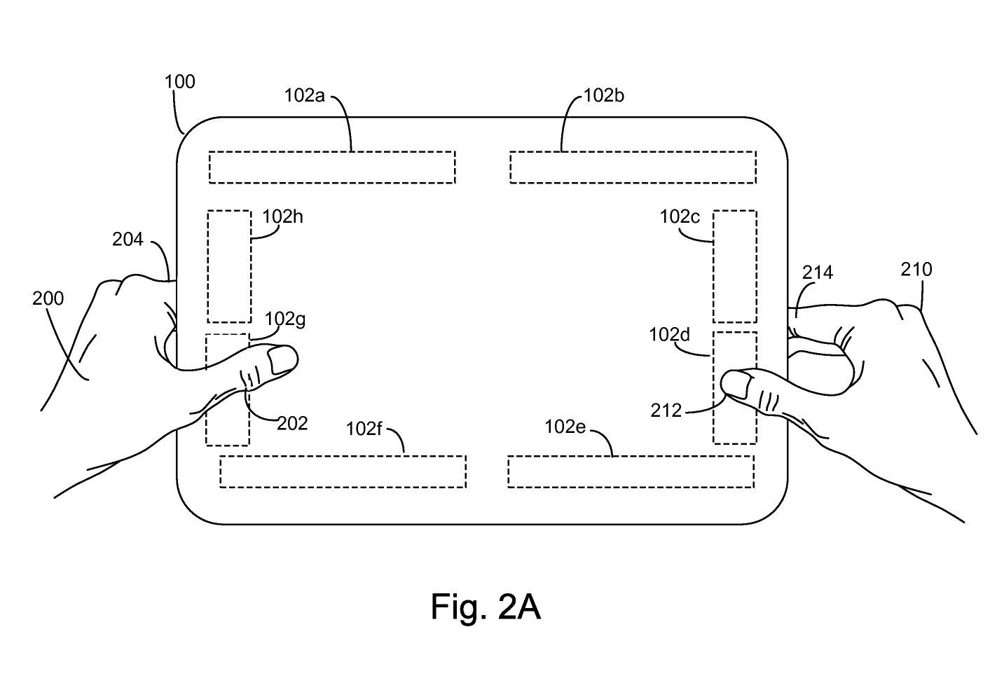

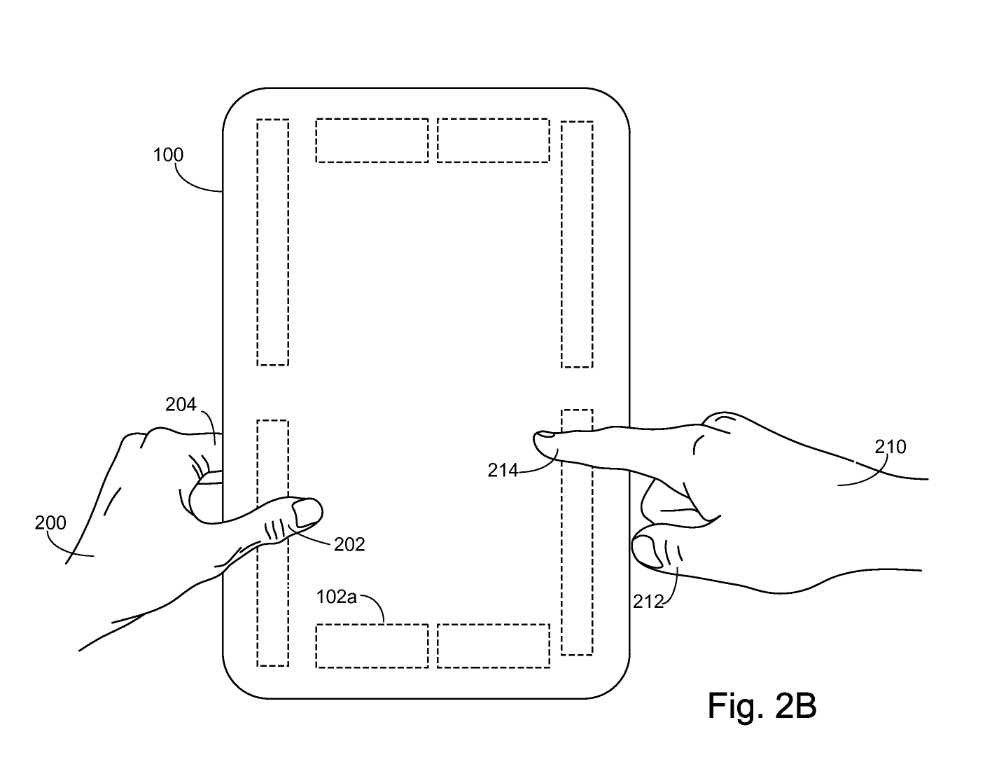

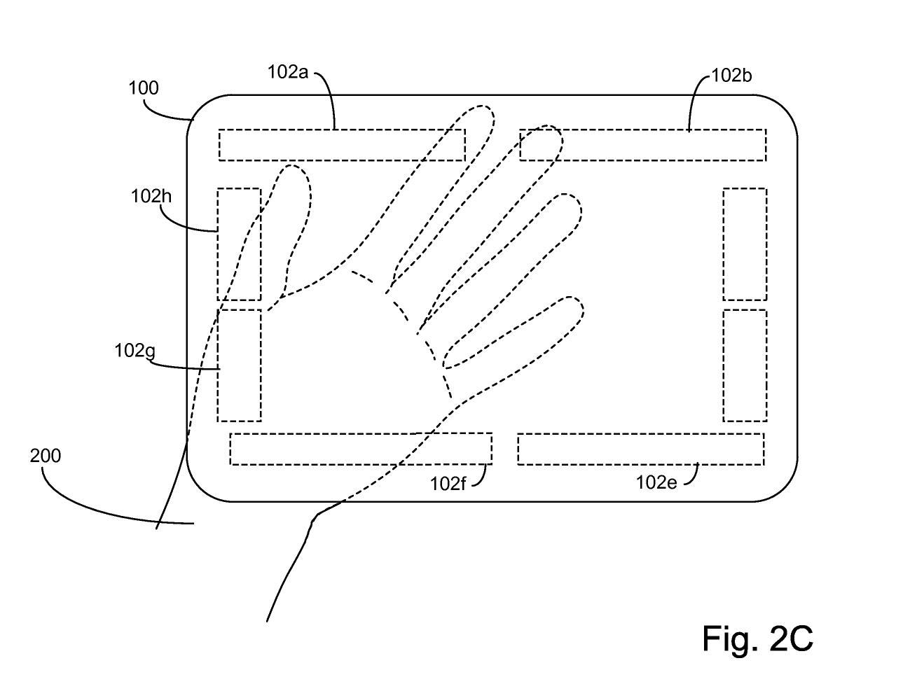

The relationship of the touch sensors to a user's hand when the user is holding the PTS device is shown in one embodiment in FIG. 2A. In FIG. 2A, the user is holding the PTS device in a horizontal position (e.g., the rectangular shape on its “side” relative to the user viewing the device). How the user is holding the device (e.g., horizontally) should not be confused with how the display screen is oriented (e.g., display mode). These display modes are commonly referred to as “landscape” or “portrait” mode. Conventionally, the landscape mode is used when the device is horizontally positioned, and in the portrait mode when vertically oriented. However, as it will be seen, this type of conventional operation is not always desirable. It may be desirable to retain, e.g., the landscape display mode even though the device is titled to an extent that would otherwise cause reorienting the display contents.

The various touch sensors 102 are shown with dotted lines since the view depicts the front side of the device, e.g., the user is holding the device so as to see the display screen. Thus, the touch sensors in FIG. 2A are on the back of the device, and are transposed relative to FIG. 1. In other words, touch sensor 102a is on the upper right corner in FIG. 1 when viewed from the back of the device, but is shown in the upper left corner in FIG. 2 when viewed from the front of the device.

The user may hold the device in various ways, and the left hand 200 is shown in FIG. 1 with the left index finger 204 behind the device. In various embodiments, the user's finger 204 may be contacting the bottom of touch sensor 102h and/or the top portion of touch sensor 102g. It is expected that the user would be touching at least one of the touch sensors 102h, 102g when holding it such. A similar position is shown for the right hand 210, with the index finger 214 touching the touch sensor 102c and/or 102d. In this embodiment, the user is shown as “pinching” the PTS device 100 between the thumbs 202, 212 and index fingers 204, 214. In other embodiments, the PTS device may be held in part by pressing on the sides of the edges of the device, with the device nestled between the palms of the hands 200, 210. In this arrangement, the fingers typically still contact the back portion of the device.

FIG. 2A illustrates one embodiment which is a “two-handed” approach or usage position for holding the device. In distinction, FIG. 2B illustrates one embodiment of a “one-handed” usage position for holding the device. In FIG. 2B, the device 100 is illustrated in a vertical position. In this embodiment, the user is using the left hand 200 to hold the device by squeezing or pinching the device between the left index finger 204 and the thumb 202. In other embodiments, the palm of the hand may also be contacting the side of the PTS device 100. The right hand 210 is shown in a pointing position, where the index finger 214 may be pressing or hovering over the display screen. The right thumb 212 is not contacting the device. Thus, in this embodiment, the left index finger 204 is contacting only one touch sensor 102a, and no support is provided by the right hand.

Another embodiment is illustrated in FIG. 2C. In FIG. 2C the device 100 is shown in a horizontal usage position, with the left hand 200 holding the PTS device. The portion of the left hand that is behind the device is illustrated with a dotted line. It is apparent that portions of the hand are contacting touch sensor elements 102f, 102g, 102h, 102a, and 102b.

Other typical usage positions for contacting the device include placing the device on the user's leg or lap. In these positions, corresponding contact patterns can be detected from the various touch sensors. For example, if the device is in a horizontal position balanced on a user's leg, there may be only contact with the top and bottom touch sensors 102a, 102b, 102f, and 102e. If the device is in a horizontal position in the user's lap, then there may be only contacts with side touch sensors 102h, 102g, 102c, and 102d. Other sensors may be used to further detect contact with the user.

The signals from the touch sensor can be analyzed by a processor in the device to determine information about the usage position, including the user's posture and how the device is being held. Other inputs may be received by the processor and include signals from an accelerometer detecting the device's position relative to gravity. Thus, the device can detect tilt or orientation, e.g., whether it is horizontally positioned or vertically positioned and well as movement. The inputs from the touch sensor by itself, or in combination with the accelerometer can be used by the processor to configure the layout of the screen content, or otherwise control operation of the device. As used herein, “display screen content,” “screen content,” or “screen layout” refers to the images presented on the display screen. The “display screen” (sans “content”) refers to the physical display area, which is fixed in size and area by the hardware of the device. Thus, the display screen cannot be changed, but the screen content or screen layout can be reconfigured by software.

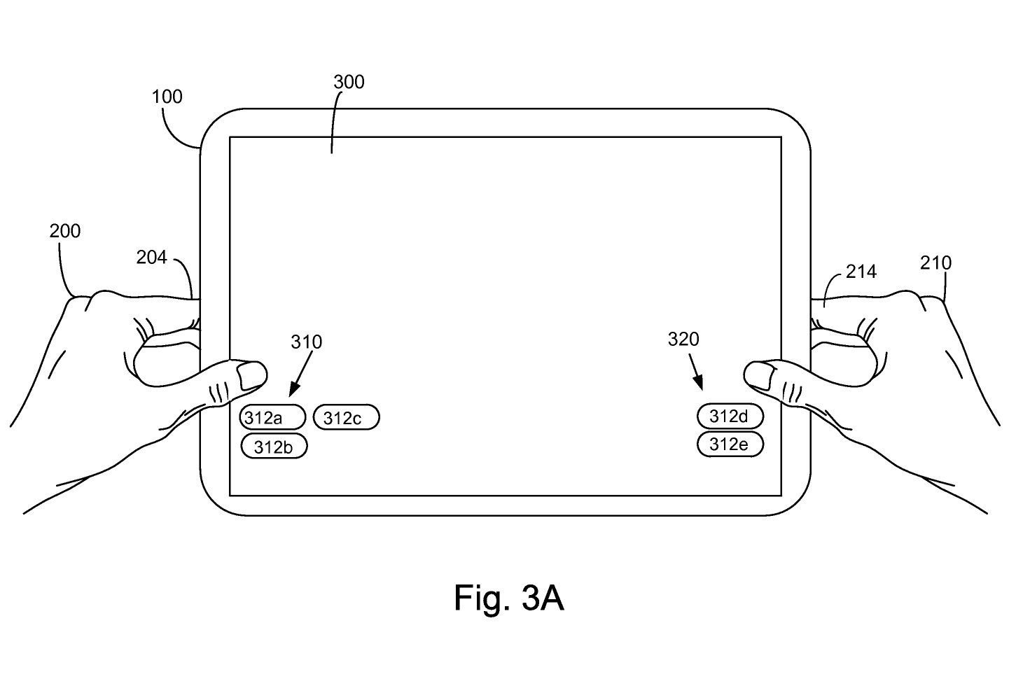

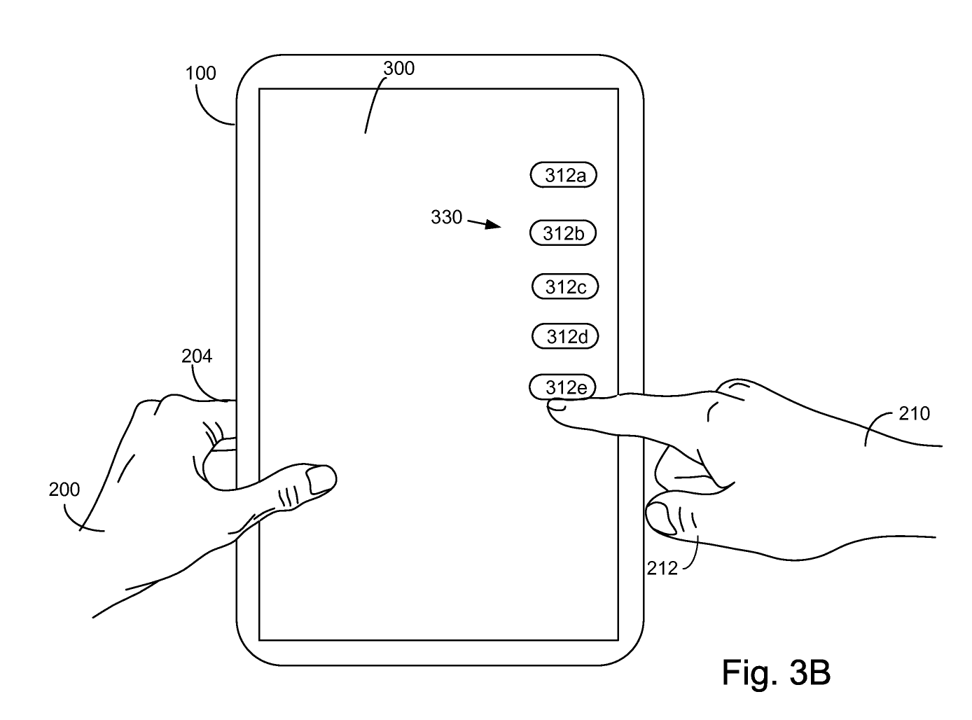

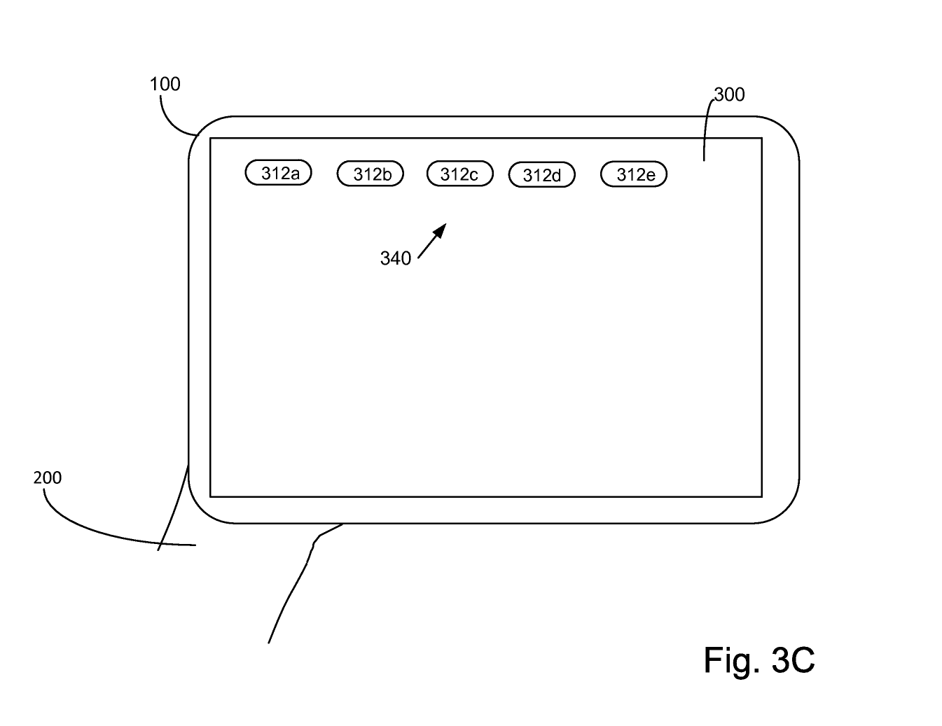

One embodiment of how screen layout can be configured based on touch sensor input is shown in FIG. 3A. In this embodiment, the user is viewing the screen 300 of the device 100 using two hands 200, 210, with the fingers 204, 214 contacting the back of the device. The touch sensors are not shown in FIG. 3A, but may correspond to the layout shown in FIG. 2A.

In FIG. 3A, two groupings 310, 320 of icons are presented on the touch screen 300, and are referred to as virtual keys. These icons can be generated by the operating system or application program executing on the processor. It is well known that selection of the function is accomplished by touching the touch screen over the virtual key to invoke the indicated function. One grouping 310 comprises icons 312a, 312b for three virtual keys positioned on the left side of the touch screen, and another grouping 320 represents two more functions 312d, 312e which are positioned on the right side of the touch screen. In this embodiment, the sensors detect a two hand usage position, and arrange to divide the set of available virtual keys on the left side and right side to facilitate tapping the touch screen using the corresponding thumbs (a form of data input referred to as “thumbing”). In this manner, the user can readily use their appropriate thumb for tapping a virtual key.

FIG. 3B illustrates another display content configuration when the device is vertically oriented, and the user is using one hand 200 to hold the device. The user's finger 204 is positioned behind the device, and hence only touch sensors from one side of the tablet are detected using touch sensors. In this configuration the device can determine that the user is holding the device on the left side based on the touch sensor indicating contact with the left side sensors. In response, the application program can present virtual keys 312a-312e in a grouping 330 on the right side of the touch screen. This particular one-handed usage configuration can be further sub-categorized as either a left-handed or right-handed usage configuration. Thus, in a variation of the embodiment of FIG. 3B, the right hand 210 may hold the device, and the left hand 200 may be selecting the virtual keys. In this embodiment, the virtual keys would be presented on the left side of the screen. Reference to “right” or “left” is made with reference to the front side of the device.

Another embodiment display content configuration corresponding to the single hand configuration of FIG. 2C is shown in FIG. 3C. In FIG. 3C, the device is being viewed by the hand 200 holding the device 100 in the palm in the hand. Thus, typically, the display screen is parallel to the ground, or slightly tilted. (If the display screen was vertical, the device would slide down and off the user's hand.) In this illustration, most of the hand is behind the device, and hence is not visible from this perspective. In this configuration, the fingers may contact various touch sensors, and based on this input, or in conjunction with the input from an accelerometer, the device can ascertain that the user's thumbs are not readily available for use in this usage position. Consequently, virtual keys 312a-312e can be positioned as a grouping 340 across the top of the screen. In other embodiments, the device may recognize whether the left-hand or right-hand is used to hold the device. A similar screen configuration can be used if the device is detected as being positioned in the user's lap.

The above illustrates how the device can use touch signals to determine how the device is being held, and how to potentially control the display of information to a user based on how it is being held. The touch signals can be analyzed further to indicate other potential types of usage positions. For example, when the device is positioned face up on a table and used for typing input, the touch contacts from the sensors on the backside will tend to evenly contact the table surface. Thus, the touch signals generated may be similar in nature. Further, any variations in the touch signals may coincide with typing input (which may cause increased contact on a touch sensor). In contrast, if the user is typing with the device positioned in their lap, it can be expected that the device will be unevenly positioned, and there will be more significant variation of the touch signals. Thus, it is possible to ascertain with a certain likelihood whether the device is horizontally positioned on a table, or on a user's lap. Based on the location of contact, it can be further distinguished if the user has balanced the device on their leg, when they are in a sitting position. In such cases, the display can be configured so that inputs are positioned in the middle of the screen. This screen display configuration can mitigate tilting the device when the user presses a virtual key.

The usage position ascertained by the touch signals can be augmented by using other inputs, such as an accelerometer. An accelerometer can be used to detect a static position (such as tilt, angle, or orientation), or a dynamic movement (motion). This input can be processed along with touch sensor input to more accurately detect the positional usage of the device, and modify the operation accordingly. However, accelerometers provide measurements relative to gravity and thus the orientation information from the accelerometer is with respect to gravity. To refer to one end of the device as being “up” in associated with the accelerometer refers to the side away from the ground. This may not always coincide with what the viewer views as “up” when viewing the screen. For example, if the user is viewing a device while lying on a couch on their side, looking “up” to the top of the screen may not coincide with “up” relative to gravity. The distinction becomes more subtle if the user is positioned to view the display at an angle.

As noted, usage position ascertained by analyzing the touch signals can be augmented by using other inputs, such as an accelerometer. For example, if the device is being used in a user's lap, straddling their legs, it can be expected that the touch sensors on the side of the device (regardless of whether the device is oriented horizontally or vertically from the user's view) will register contact with the user's legs. Thus, touch signals from the two side contacts are expected to be generated in this configuration.

As discussed, the signal variation is likely to be greater during use than if the device is placed on a solid surface, e.g., a table. Whether the device is being used on a table or on a person's lap may be distinguished by solely analyzing the touch signals, but this determination may be augmented by also considering the accelerometer signals. If the device is on a table, the accelerometer signals will indicate that the device is not in motion. If the device is located in a user's lap, there likely is to be some limited motion. Further, if the device is located on a level surface on a table, this can also be detected with the accelerometer. Rarely would use in the device on a person's lap result in the device being perfectly level over time. Thus, the touch signals and accelerometer can be used to distinguish between these two usage positions.

Using a combination of touch signals and the accelerometer can provide a more accurate determination of the usage position and the user's posture, and allow more accurate control of the device for a better user experience. For example, some devices are configured with an accelerometer to detect tilt of the device, and re-orient the display accordingly. Thus, if the device is held horizontally (see, e.g., FIG. 2A), then the screen is displayed in a landscape mode. Similarly, if the device is held vertically, the screen is displayed in a portrait mode. These devices will automatically convert from one display mode to another based on detecting an updated position of the device.

However, using the orientation information alone from the accelerometer does not always result in satisfactory operation. Recall that the accelerometer determines an orientation with respect to gravity. A user viewing the device in their hand will have a different reference when, for example, they are lying down or trying to position the device to share images for viewing.

For example, a salesperson may use a PTS device to access information, and present the information to a customer standing nearby. It is likely that the user would use the device according to one of the embodiments shown in FIG. 2A-2C, and then use one hand as shown in FIG. 2B tilt the display screen to show it to another person. Using an accelerometer only may result in interpreting the a new position of the device resulting in rotating the screen orientation. This operation may not be desirable, since it was not necessarily the intent of the user to reorient the display. The user has to then reposition the device so that the other person can see the images properly.

The device could process the touch signals and be aware that the device was being grasped by a user in one hand both prior to being titled and while the device is being tilted. The touch signals could then modify the screen reorientation algorithm so that the screen would not be reoriented if the same touch sensors were used by one hand during movement. Or in other words, changing from a two hand to a one hand usage position, involving the same subset of sensors is suggestive of the user tilting the tablet, not deliberately rotating it. Thus, using touch sensor signals, coupled with the accelerometer signals, would indicate that the user intended to reposition the device without reorientation of the screen display. If the user intentionally rotated the device, the new positioning could be confirmed by detecting touch signals on a different set of touch sensors.

Another example of how touch signals can be used in conjunction with the accelerometer signals to properly orient a screen layout is when the device is used by a user in a prone position. For example, a user may be viewing the device while lying on a couch, or shifting position. The accelerometer may indicate a value of tilt that exceeds a threshold value and that normally would cause the device to reorient the screen display content. In such a position, the user would still typically touch the device at what the user considers as to be the side(s) of the device (using one or two hands). In such applications, it would be desirable to maintain the screen layout orientation, and only change the orientation when there is a change in the detection of the touch sensors. For example, if the person intended to rotate the physical device, they would likely touch sensors that were orthogonal to the sensors previously touched.

The touch signals either by themselves, or in conjunction with the accelerometer signals, could also impact other operational aspects. For example, entering or exiting a sleep or a locked mode of the device can be better detected by using touch signals in combination with the accelerometer as opposed to using accelerometer signals alone. The usage of a device can be detected by the presence of touch signals as well as movement of the device. For example, a user carrying a PTS device in their pocket, purse, or briefcase would result in the accelerometer sending signals indicating movement, but there would be an absence of expected touch signals suggesting the user's fingers are actually holding the device. If the device is being held and there is movement, this suggests the user is using the device. Typically, entry into sleep mode is triggered by a timer, and setting the value of the timer may be impacted by analysis of the touch signals in addition to the accelerometer signals.

Similarly, if the device is in sleep mode, and the device is picked up, the accelerometer will detect movement, but this by itself is not indicative of whether the user is merely taking the device with them, or intends to use the device. If the touch sensors detect a touch pattern that is consistent with using the device, then the device can automatically awake. A user intending to use the device will likely hold the device as if there were actually using it. The use of touch signals in conjunction with the accelerometer allows the device to better anticipate the user's intentions, and can result in better power management by turning off the display when it is not needed. In addition to entering the sleep mode, the device can enter a locked state faster, providing greater security.

The processing of touch signals by the processor can be based on a probability threshold that is refined based on usage of the device over time. While the device is being used, information about which touch sensors are being used can be stored as indicative of a usage position. For example, users are typically left-handed or right handed, so that they will consistently hold the device with the same hand. The touch sensors involved can be stored and can be referenced at a later time.

Returning to FIG. 2B, touch sensor 102a is likely to be consistently used when the same user holds the device with one hand. Thus, when the device is picked up from a locked or sleeping state, detection of signals from only sensor 102a is indicative of use. This information coupled with accelerometer information could inform the device that it is likely that the user is holding the device and intends to use the device.

For example, a user picking up a device will likely result in great acceleration as it is lifted off of a table, followed by no movement when it is positioned to be used. In order to distinguish this from a user merely picking up the object, the touch signals can be compared to see if the user is holding it in a manner consistent with a usage pattern. The touch signals may be stored in different profiles associated with different usage positions. Thus, there may be a usage profile for one handed use, two-handed use, etc. The profile can be adjusted to adapt to changing user habits.

It also should be understood that the illustrated methods can be ended at any time and need not be performed in its entirety. Some or all operations of the methods, and/or substantially equivalent operations, can be performed by execution of computer-readable instructions included on a computer-storage media, as defined above. The term “computer-readable instructions,” and variants thereof, as used in the description and claims, is used expansively herein to include routines, applications, application modules, program modules, programs, components, data structures, algorithms, and the like comprising non-transitory signals. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts, and modules may be implemented in software, in firmware, in special purpose digital logic, and any combination thereof For purposes of illustrating and describing the concepts of the present disclosure, the methods disclosed herein are described as being performed by a computer executing an application program. Thus, the described embodiments are merely exemplary and should not be viewed as being limiting in any way.

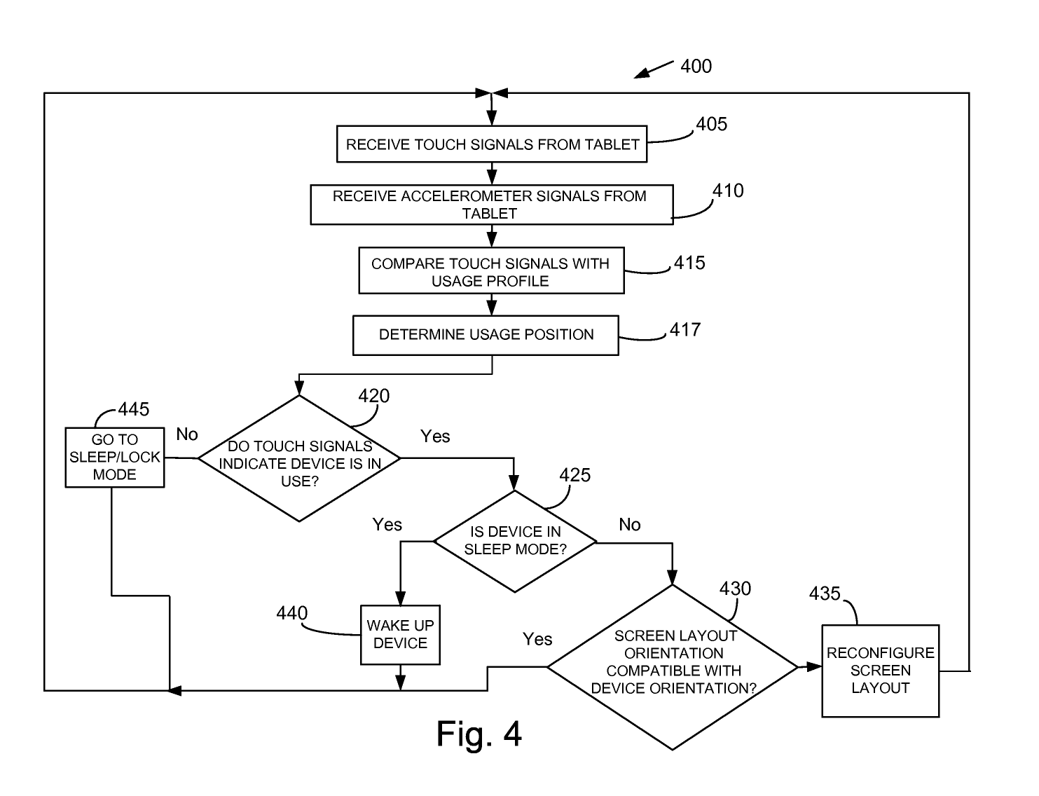

One process flow for processing touch signals is shown in FIG. 4, which illustrates one embodiment for processing touch signals in combination with accelerometer signals for affecting the operation of the PTS device. In FIG. 4, the signals from the various touch sensors are received in operation 405 and the processor is able to ascertain which particular sensors in contact with the user. It may also be possible to ascertain a pressure based on the signal profile. In operation 410, the processor also receives accelerometer signals from the accelerometer which provide both static (e.g., tilt) and dynamic accelerometer data (motion). The static information can be used to ascertain tilt, position, or orientation with respect to gravity, whereas dynamic data can indicate motion.

In operation 415, the processor may access prior touch data that has been stored in a usage profile that is associated with a particular manner in which the device has been used. This usage profile may be generated and stored in non-volatile memory as the device is being used, so that current touch sensor data can be compared with the usage profile for analyzing if and how the device is being used. The touch data may not be limited to touch sensor data, but may also include accelerometer data indicating detected tilt or other positional aspects.

In operation 417, the processor analyzes the touch data and accelerometer data to ascertain the device's position and orientation and intended usage. The process can analyze which sensors are being contacted, how long they have been contacted, as well as the tilt and movement of the device. Thus, a continuous signal from a set of touch sensors may suggest that the user is holding the device. The accelerometer can indicate which touch sensor is oriented “up”, and therefore can determine which side of the device is being held. It may be more common for a user to hold the device at its side, as opposed to at its top, when it is in use.

The accelerometer can also indicate whether the device is relatively stationary. Thus, analysis of this data can, for example, distinguish between a user carrying the device while walking by holding the device with one hand in their curled fingers, with their arm straight at their side, versus a user holding the device with one hand while they are viewing the screen in a standing position. In the former case, the touch sensor would likely originate from the “bottom” touch sensor because the user has curled their fingers and the device is being held very close to vertical.

The accelerometer would indicate that whatever side is pointed down is the “bottom” side, regardless of how the device is position. Thus, in this carrying mode, regardless of which sensor is being contacted, it would be at the bottom. Further, while walking, a periodic motion would be detected by the accelerometer. In the latter case, the touch sensor would originate from the “side” of the device, and the device would be slightly tilted while the user looks at the screen. Further, if the user is standing, there would likely not be any periodic motion. Certain users will develop certain habits as to how they use the device, and these characteristics can be stored and compared with currently generated signals to ascertain if the device is being used.

If, in operation 420, the analysis indicates the device is not being used, then in operation 445, the device can enter into a sleep mode, or a locked mode. The process flow then returns to operation 405 where the touch signals are received and analyzed again. This repetition of this process of receiving and analyzing the signals can be continuous, or occur in periodic timed intervals, or based on some other trigger.

If, in operation 420 the analysis suggests that the device is in use, then the test shown in operation 425 is performed. In operation 425 the determination is made if the device is already in a sleep (or locked) mode, and if so, then in operation 440, the device wakes up (or presents a display for unlocking the device). If the device is not in sleep mode in operation 425, then the flow proceeds to operation 430 where an analysis of the current screen orientation is made with the previously determined analysis of the orientation of the device. A determination is made whether the orientation of the screen is correct given the usage of the device. If the orientation is correct, the flow proceeds back to operation 405 where the process repeats. If the screen layout orientation in operation 430 is not compatible with the device orientation, then the screen layout is reconfigured in operation 435.

The reconfiguration of the display content does not necessarily require rotating the contents of the screen layout. Other forms of reconfiguration are possible, and include reconfiguring the screen content differently. For example, while the screen display and screen layout are in the landscape mode, the content can be organized differently, as shown in FIG. 3A and FIG. 3C. This can reflect how the device is being held and used, which is not merely determining how the device itself is oriented with respect to gravity.

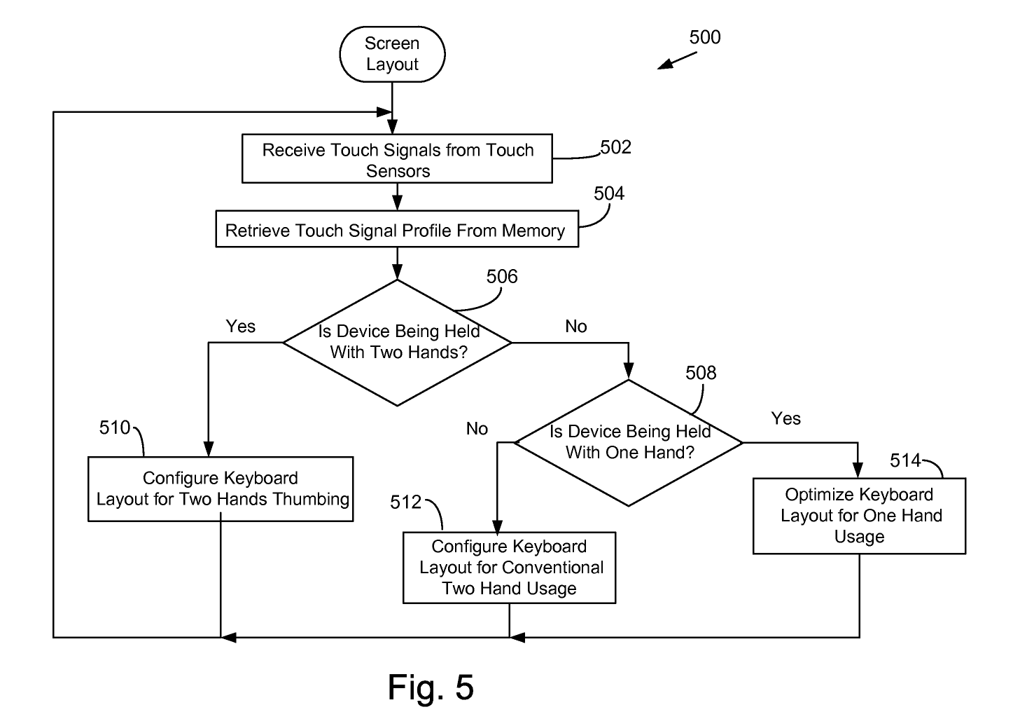

The process flow of FIG. 4 can vary, and those skilled in the art will recognize that additional, or fewer operations can occur. For example, another embodiment of the process flow for processing touch sensor signals is shown in FIG. 5. In FIG. 5, the process begins in operation 502 with the processor receiving touch signals from the touch sensors. In operation 504, a usage profile is retrieved from memory based on past usage patterns, or an initial usage profile programmed into the device. In operation 506, the processor analyzes whether the device is being held with two hands, as previously discussed in conjunction with FIG. 2A and FIG. 3A. If the device is being held with two hands, then in operation 510 the processor can optimize the virtual keyboard layout for the virtual keys for two handed “thumbing” use. It is possible that the user may have previously indicated a preference for a particular type or style of split keyboard configuration that facilitates key selection by using thumbs. A split keyboard is one where the grouping of keys is divided so as to facilitate each hand's contacting a virtual key.

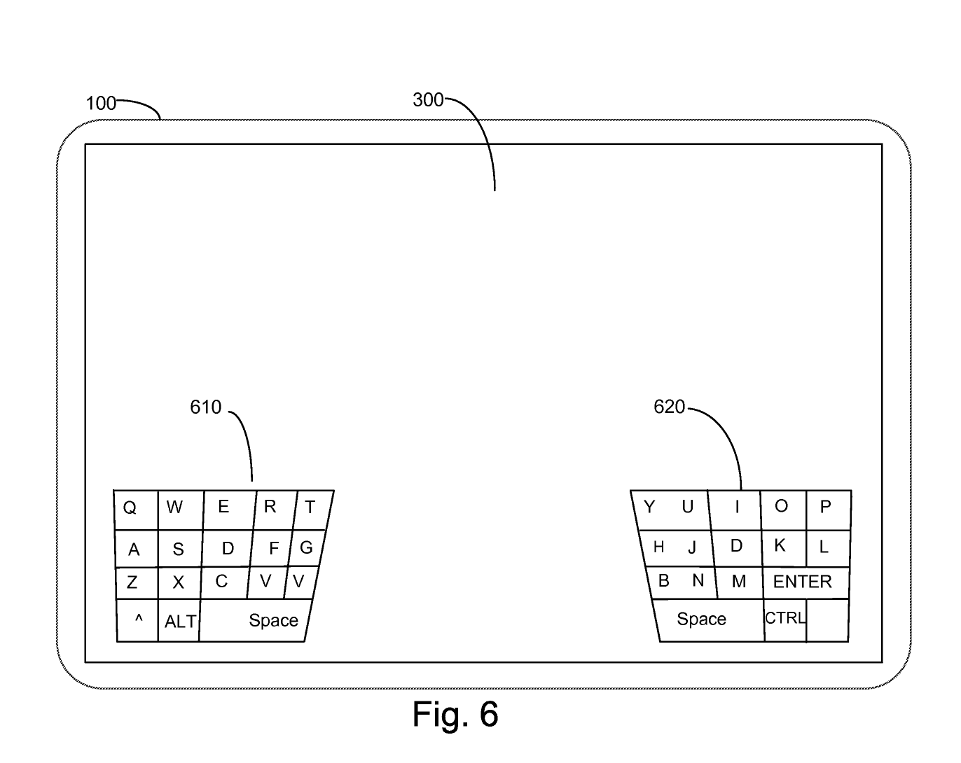

One such illustrative split keyboard layout is shown in FIG. 6. In FIG. 6, two groupings of virtual keys 610 and 620 are shown. These are located in the lower left and right corners of the display screen 300 of the device 100. This location is designed to facilitate key selection by using the left and right thumbs when the user is holding the device with two hands. The user may be able to configure aspects of the layout (e.g., size, key layouts, etc.). This screen layout can be used whenever the device detects a corresponding two handed usage. Other variations are possible.

Returning to FIG. 5, if in operation 506 the analysis shows that the device is not being held with two hands, then the analysis in operation 508 occurs. This analysis determines whether the device is being, for example, held in one hand, positioned on a table, or in the user's lap. If it is ascertained the device is not being held with one hand (e.g., the device is positioned on the user's lap or on a table), then in operation 512 the keyboard layout could be configured in a conventional (two hand usage) typing layout. If it is determined in operation 508 that the device is being held with one hand, then in operation 514, another keyboard configuration could be used. This layout could be optimized for one hand usage. For example, if the user is holding the device with their left hand, a keyboard layout could be presented that is shifted to the right. In this way, the left hand would not accidentally press a key on the left side of the keyboard. If the user holds the device with their right hand, then the keyboard could be shifted to the left side of the screen.

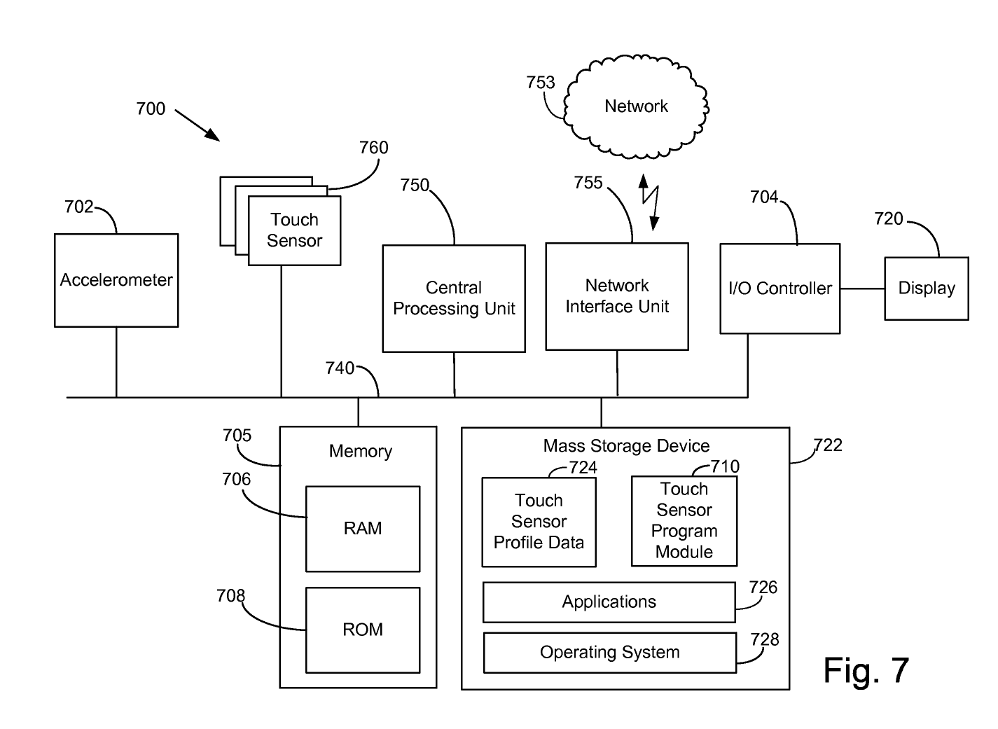

FIG. 7 illustrates one embodiment of an exemplary PTS device that can process the above flows and executing the software components described herein for controlling the device based on touch sensor data and accelerometer data.

The device 700 may include a central processing unit (“CPU”) 750 also known as a processor, system memory 705, which can include volatile memory such as RAM 706, a non-volatile memory such as ROM 708, all of which can communicate over bus 740. The bus 740 also connects with a plurality of touch sensors 760, an accelerometer 702, and an Input/Output (“I/O”) controller 704. A basic input/output system containing the basic routines that help to transfer information between elements within the computer architecture 700, such as during startup, is stored in the ROM 708.

A display 720 may communicate with the I/O controller 704, or in other embodiments, may interface with the bus 740 directly. The input/output controller 704 may receive and process input from a number of other devices, including a keyboard, mouse, or electronic stylus (not shown in FIG. 7). Similarly, the input/output controller 704 may provide output to a printer, or other type of output device (also not shown in FIG. 7).

The device may also comprise an accelerometer 702 which can provide data to the CPU 750 regarding the tilt, orientation, or movement of the device 100. The CPU 750 is able to periodically receive information from the accelerometer 702, the touch sensors 760, and access data and program instructions from volatile memory 706 and non-volatile memory 708. The processor can also write data to volatile memory 706 and non-volatile memory 708.

The mass storage device 722 is connected to the CPU 750 through a mass storage controller (not shown) connected to the bus 740. The mass storage device 724 and its associated computer-readable media provide non-volatile storage for the computer architecture 700. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 700.

The non-volatile memory 708 and/or mass storage device 722 may store other program modules necessary to the operation of the device 100. Thus, the aforementioned touch sensor profile data 724, which may be referenced by the processor to analyze touch data, may be stored and updated in the mass storage device 722. The touch sensor module 710 may be a module that is accessed by the operating system software 728 or an application 726 stored in the mass storage memory of the device. The touch sensor module 710 may accessed as a stand-alone module by the operating system or application.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 700. For purposes the claims, the phrase “computer storage medium” and variations thereof, does not include waves, signals, and/or other transitory and/or intangible communication media, per se.

According to various embodiments, the computer architecture 700 may operate in a networked environment using logical connections to remote computers through a network such as the network 753, which can be accessed in a wireless or wired manner. The computer architecture 700 may connect to the network 753 through a network interface unit 755 connected to the bus 740. It should be appreciated that the network interface unit 755 also may be utilized to connect to other types of networks and remote computer systems, for example, remote computer systems configured to host content such as presentation content.

It should be appreciated that the software components described herein may, when loaded into the CPU 750 and executed, transform the CPU 750 and the overall computer architecture 700 from a general-purpose computing system into a special-purpose computing system customized to facilitate the functionality presented herein. The CPU 750 may be constructed from any number of transistors or other discrete circuit elements, which may individually or collectively assume any number of states. More specifically, the CPU 750 may operate as a finite-state machine, in response to executable instructions contained within the software modules disclosed herein. These computer-executable instructions may transform the CPU 750 by specifying how the CPU 750 transitions between states, thereby transforming the transistors or other discrete hardware elements constituting the CPU 750.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 700 in order to store and execute the software components presented herein. It also should be appreciated that the computer architecture 700 may include other types of computing devices, including hand-held computers, embedded computer systems, personal digital assistants, and other types of computing devices known to those skilled in the art. It is also contemplated that the computer architecture 700 may not include all of the components shown in FIG. 7, may include other components that are not explicitly shown in FIG. 7, or may utilize an architecture completely different than that shown in FIG. 7

In general, the touch sensor module 724 allows the device to process touch sensor data, and also process accelerometer data for purposes of controlling the contents presented on display 720. The touch sensor module may also access the touch sensor profile data 724 if needed. In general, the touch sensor program module 710 may, when executed by processor 760, transforms the processor 760 and the overall device 700 from a general purpose computing device into a special-purpose computing device for controlling operation and/or the display of the device. The processor 760 may be constructed from any number of transistors, discrete logic elements embodied in integrated circuits, and may be configured as a multiple processing core system, a parallel processing system, or other processor architecture forms known in the art.

Based on the foregoing, it should be appreciated that technologies for receiving and processing touch sensor data and controlling the operation or display of a PTS device have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

For example, the principles of the present invention can be applied to other portable devices which incorporate processors, but may not incorporate touch screens. For example, cameras having digital displays, but which are not touch screen capable. These portable devices can benefit from incorporating touch sensors and accelerometers and processing the signals to ascertain how the display should be reoriented, or whether the device should enter/exit a sleep mode.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

1. A system for controlling operation of a portable touch screen (“PTS”) device having a front side comprising a screen display and a back side, the system comprising:
a plurality of touch sensors positioned on the back side of the PTS device providing touch sensor signals when touched by a user;
an accelerometer in the PTS device providing accelerometer signals comprising orientation signals indicative of an orientation of the PTS device and tilt signals indicative of a tilt of the PTS device; and
a processor receiving and analyzing both the touch sensor signals and the accelerometer signals, wherein the processor is configured to
determine a usage position of the PTS device by the user holding the PTS device using the touch sensor signals and the accelerometer signals, and
reconfigure the display content configuration based on the usage position.

2. The system of claim 1 wherein the processor is further configured to:
determine that the usage position of the PTS device comprises the user holding the PTS device with two hands; and
reconfigure the display content configuration for two handed operation in response to determining the usage position.

3. The system of claim 1 wherein the processor is further configured to:
determine that the usage position of the PTS device comprises the user holding the PTS device with one hand; and
reconfigure the display content configuration by displaying virtual function keys on one side of the display screen.

4. The system of claim 3 wherein the usage position is determined to be holding the PTS device with a left hand, and reconfiguring the display content configuration comprises displaying function keys on a right side of the display screen.

5. The system of claim 1 further comprising non-volatile memory wherein the processor is further configured to:
store data representative of touch sensor usage in the non-volatile memory in association with the usage position.

6. The system of claim 5 wherein the processor is further configured to:
use the stored data representative of touch sensor usage in conjunction with the touch sensor signals and the accelerometer signals to determine the usage position.

7. The system of claim 2 wherein reconfiguring the display content configuration based on the usage position comprises displaying a split virtual keyboard on the display screen.

8. The system of claim 1 wherein reconfiguring the display screen content configuration based on the usage position comprises turning off the display screen.

9. The system of claim 7 wherein displaying a split virtual keyboard on the display screen occurs only if the usage position indicates the PTS device is horizontally positioned.

10. A computer implemented method for controlling the configuration of a display on a portable device, comprising:
receiving touch sensor data from a plurality of touch sensors positioned on a back of the portable device when touched by a user;
determining a usage position of the portable device by the user holding the portable device;
determining a current display content configuration presented on a display of the portable device, and
reconfiguring the display content configuration based on the usage position reflecting two handed operation by the user.

11. The computer implemented method of claim 10 wherein the two handed operation is for two-handed thumbing, and the reconfiguration of the display content configuration presents a split virtual keyboard on the display screen.

12. The computer implemented method of claim 11 further comprising:
receiving subsequent touch sensor data from the plurality of touch sensors;
determining a change in the usage position of the portable device by the user holding the portable device; and
reconfiguring the display screen content configuration based on the change in the usage position to present a non-split virtual keyboard on the display screen.

13. The computer implemented method of claim 12 wherein the presentation of the non-split virtual keyboard is presented in conjunction with a portrait display mode.

14. A computer-storage medium having non-transitory computer-executable instructions stored thereon which, when executed by a computer, cause the computer to:
receive touch sensor data from a plurality of touch sensors positioned on a back of a PTS device when touched by a user;
receive accelerometer signals comprising configuration signals indicative of an orientation of the PTS device and tilt signals indicative of a tilt of the PTS device;
analyze both the touch sensor signals and the accelerometer signals to determine a usage position of the PTS device by the user holding the PTS device;
determine a current display content configuration presented on a display screen of the PTS device; and
reconfigure the display content configuration based on the usage position wherein the display content configuration comprises a virtual split keyboard.

15. The computer-storage medium of claim 14 further comprising additional instructions which when executed by the computer, cause the computer to:
determine the usage position of the PTS device comprises the user holding the PTS device with two hands; and
reconfigure the display screen content configuration for two handed thumbing in response to determining the usage position.

16. The computer-storage medium of claim 14 further comprising additional instructions which when executed by the computer, cause the computer to:
determine the usage position of the PTS device comprises the user holding the PTS device with one hand; and
reconfigure the display content configuration by configuring the contents to display function keys on one side of the display screen.

17. The computer-storage medium of claim 16 wherein the usage position is determined to be holding the PTS device with the left hand, and reconfiguring the display content configuration comprises displaying function keys on the right side of the display screen.

18. The computer-storage medium of claim 14 further comprising additional instructions which when executed by the computer, cause the computer to:
store data representative of touch sensor signals and accelerometer signals in the non-volatile memory in association with the usage position; and
use the stored data in conjunction with the touch sensor signals and the accelerometer signals to determine the usage position.

19. The computer-storage medium of claim 14 wherein reconfiguring the display content configuration based on the usage position comprises displaying the split virtual keyboard on a lower portion of the display screen.

20. The computer-storage medium of claim 14 wherein reconfiguring the display configuration based on the usage position comprises subsequently turning off the display screen.
